(19) United States
(12) Patent Application Publication
(10) Pub. No.: US 2013/0159429 A1
(43) Pub. Date: Jun. 20, 2013

(54) SHARING AND TRANSFERRING MESSAGE CONTENT BETWEEN USERS

(71) Applicants: Selvaraj Nalliah, Redmond, WA (US); Edward Thomas Banti, Seattle, WA (US); Bethany Kessen Doan, Austin, TX (US)

(72) Inventors: Selvaraj Nalliah, Redmond, WA (US); Edward Thomas Banti, Seattle, WA (US); Bethany Kessen Doan, Austin, TX (US)

(73) Assignee: MICROSOFT CORPORATION, Redmond, WA (US)

(21) Appl. No.: 13/330,114

(22) Filed: Dec. 19, 2011

(51) Int. Cl. G06F 15/16

(52) U.S. Cl. 709/206

(57) ABSTRACT

Messaging content that is associated with a user is selected for sharing and transferring with one or more other recipients. A user may select all/portion of the messaging content to transfer. For example, a user may select a single folder from their mailbox, their entire mailbox, one or more conversation threads, one or more subjects, and the like. The selection may be made manually/automatically. For example, a user may use a graphical user interface to select messaging content to share and/or messaging content may be automatically selected based on a rule and/or some other condition. After selection, the selected messaging content is transferred to the other recipient(s) with which the user has selected for sharing/transferring. The recipient(s) of the selected messaging content may accept/decline the transfer of messaging content. Upon accepting the invitation, the messaging content is transferred and stored in the recipient's mailbox.

### BACKGROUND

A user may have important content (e.g. electronic messages) that is tied to the user's mailbox. While a user may share this content using public/shared folders, the sharing of the content may be difficult. For example, a user may not always be diligent about storing information in the shared location. Many times, a user just stores the content in their mailbox without sharing the content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Messaging content that is associated with a user is selected for sharing and transferring with one or more other recipients. A user may select all/portion of the messaging content to transfer. For example, a user may select a single folder from their mailbox, their entire mailbox, one or more conversation threads, one or more subjects, and the like. The selection may be made manually/automatically. For example, a user may use a graphical user interface to select messaging content to share and/or messaging content may be automatically selected based on a rule and/or some other condition. After selection, the selected messaging content is transferred to the other recipient(s) with which the user has selected for sharing/transferring. The recipient(s) of the selected messaging content may accept/decline the transfer of messaging content. Upon accepting the invitation, the messaging content is transferred and stored in the recipient's mailbox. The messaging content may/may not be automatically updated in response to changes to the messaging content.

### BRIEF DESCRIPTION OF THE DRAWINGS

FIG. 1 illustrates an exemplary computing device;

FIG. 2 illustrates an exemplary system for sharing messaging content from a user to one or more recipients;

FIG. 3 shows a display illustrating a messaging window that shows a user interacting with electronic messages and selecting messaging content to share;

FIG. 4 shows a process for selecting message content and recipient(s) for sharing and transferring message content;

FIG. 5 shows a process for accepting/rejecting an invitation to share message content;

FIG. 6 illustrates a system architecture used in sharing messaging content; and

FIGS. 7-13 show exemplary displays illustrating sharing and transferring messaging content.

### DETAILED DESCRIPTION

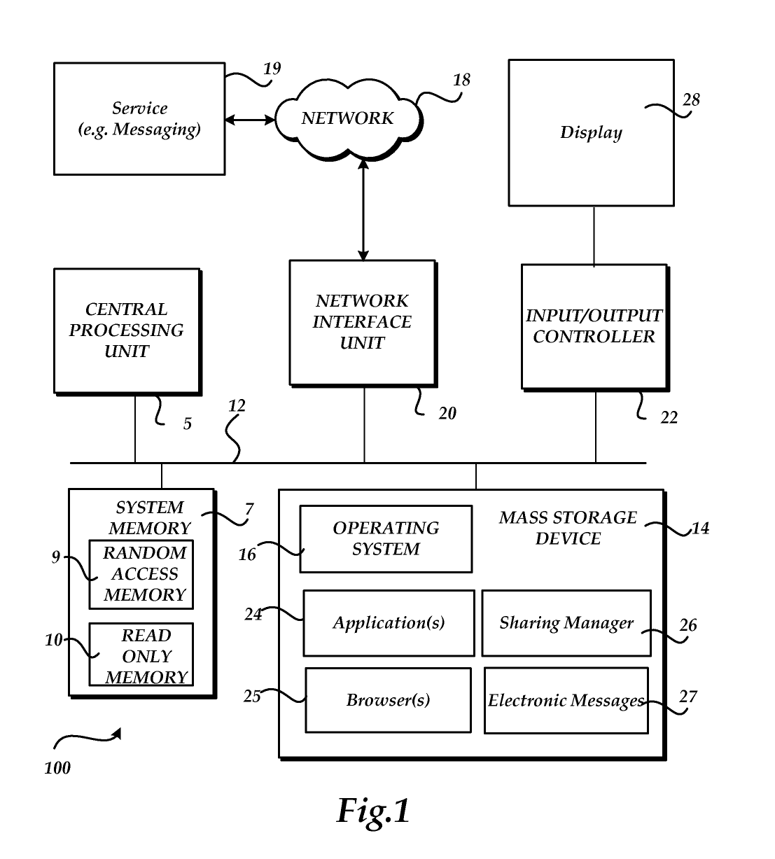

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, electronic messages 27, and other program modules, such as Web browser 25, and sharing manager 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS 7®, WINDOWS SERVER® operating systems from MICROSOFT CORPORATION of Redmond, Wash.

The mass storage device 14 and RAM 9 may also store one or more program modules. In particular, the mass storage device 14 and the RAM 9 may store one or more applications, such as sharing manager 26, messaging application(s) 24 (e.g. a messaging application such as MICROSOFT OUTLOOK, an Instant Messaging (IM) application, an SMS message, and the like), and may store one or more Web browsers 25. The Web browser 25 is operative to request, receive, render, and provide interactivity with electronic content, such as Web pages, electronic messages, videos, documents, and the like. According to an embodiment, the Web browser comprises the INTERNET EXPLORER Web browser application program from MICROSOFT CORPORATION.

Sharing manager 26 may be located on a client device and/or on a server device (e.g. within service 19). Sharing manager 26 may be configured as an application/process and/or as part of a cloud based multi-tenant service that provides resources (e.g. services, data . . . ) to different tenants (e.g. MICROSOFT OFFICE 365).

Generally, sharing manager 26 is configured to perform operations relating to sharing and transferring messaging content (e.g. electronic messages and associated content). Messaging content that is associated with a user is selected for sharing and transferring with one or more other recipients. A user may select all/portion of the messaging content to transfer. For example, a user may select a single folder from their mailbox, their entire mailbox, one or more conversation threads, one or more subjects, and the like. The selection may be made manually/automatically. For example, a user may use a graphical user interface to select messaging content to share and/or messaging content may be automatically selected based on a rule and/or some other condition. After selection, the selected messaging content is transferred to the other recipient(s) with which the user has selected for sharing/transferring. Before transferring the selected messaging content to the recipient(s), the selected messaging content may be copied to a shared location such that the messaging content remains more readily available for sharing. The recipient(s) of the selected messaging content may accept/decline the transfer of messaging content. Upon accepting the invitation, the messaging content is transferred and stored in the recipient's mailbox. The messaging content may/may not be automatically updated in response to changes to the messaging content. Additional details regarding the operation of sharing manager 26 will be provided below.

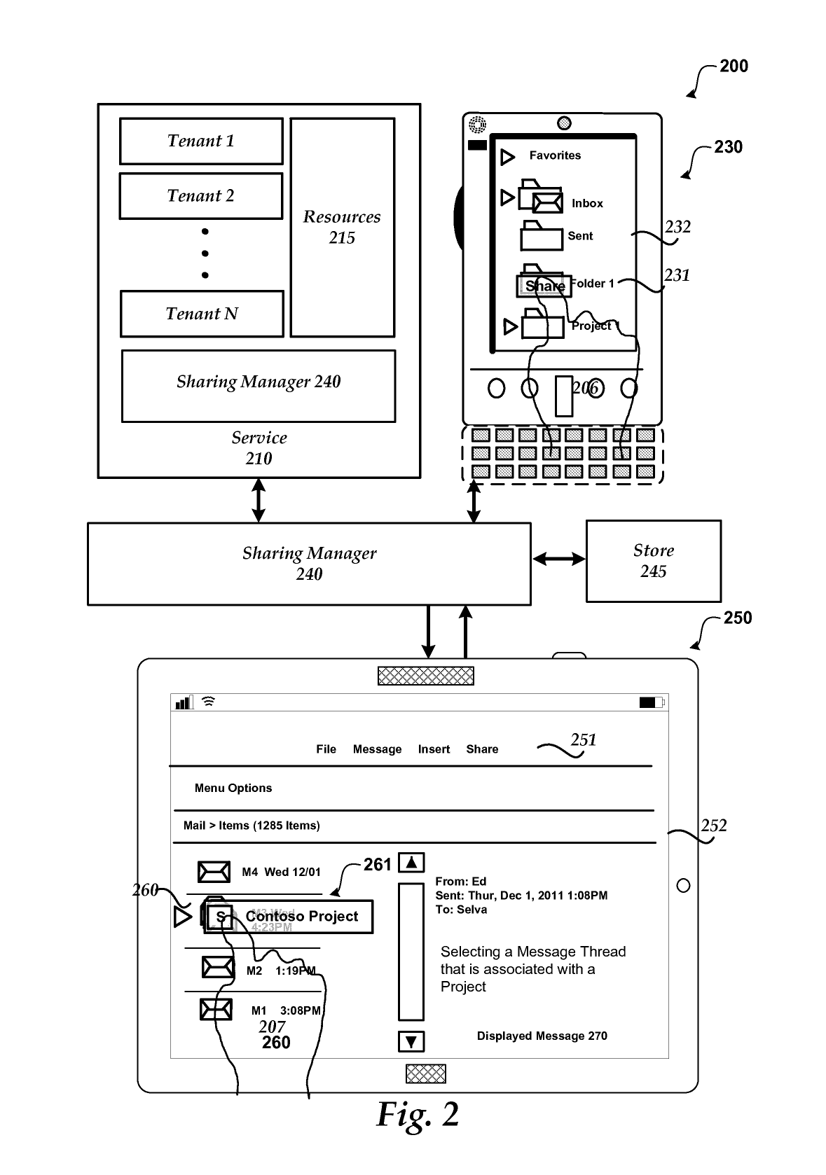

FIG. 2 illustrates an exemplary system for sharing messaging content from a user to one or more recipients. As illustrated, system 200 includes service 210, sharing manager 240, store 245, touch screen input device/display 250 (e.g. slate) and mobile device 230, such as a smartphone.

As illustrated, service 210 is a cloud based and/or enterprise based service that may be configured to provide electronic messaging services (e.g. MICROSOFT OFFICE 365 or some other cloud based/online service that provides messaging services). Functionality of one or more of the services/applications provided by service 210 may also be configured as a client based application. For example, a client device may include an application that performs operations relating to sharing/sending/receiving/interacting with messaging content, such as email messages. The messaging application/service may also provide messaging services relating to other types of messages (e.g. IM messages, SMS, MMS, and the like) Although system 200 shows a messaging service, other services/applications may be configured to use deleted property information to interact with deleted items.

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 comprises a touch screen input device/display 250 (e.g. a slate/tablet device) and mobile device 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 and mobile device 230 show an exemplary display 252/232 of messaging content that may be selected for sharing. Messaging content may be stored on a device (e.g. mobile device 230, slate 250 and/or at some other location (e.g. network store 245). Mobile device 230 shows display 232 illustrating a user's folders including messaging content shown in a list view. The messaging content may be displayed by an email program, a text messaging program, an Instant Messaging program, a messaging service, and the like. The messaging content may be displayed in a list, arranged as threads, and/or arranged in different manners. The messaging content may be displayed by a client based application and/or by a server based application (e.g. enterprise, cloud based).

Sharing manager 240 is configured to perform operations relating to sharing and transferring selected messaging content with one or more other recipients. A user may select all/portion of the messaging content to share and transfer with one or more recipients. For example, a folder 231 illustrated on mobile device 230 is selected to share. Slate device 250 shows the selection of a message thread for sharing. In response to selecting the thread to restore, UI 261 may be displayed that allows a user to see a description of the thread and a share option “S” to share the thread.

After selection, sharing manager 240 optionally sends an invitation to the selected recipient(s) to assist in determining which recipient(s) are to have the selected messaging content transferred to them. Sharing manager 240 may copy the messaging content to a shared location, such as store 245, such that the messaging content is readily available to transfer to selected recipients. Upon accepting the invitation, the messaging content is transferred and stored in the recipient's mailbox. The messaging content may/may not be automatically updated in response to changes to the messaging content.

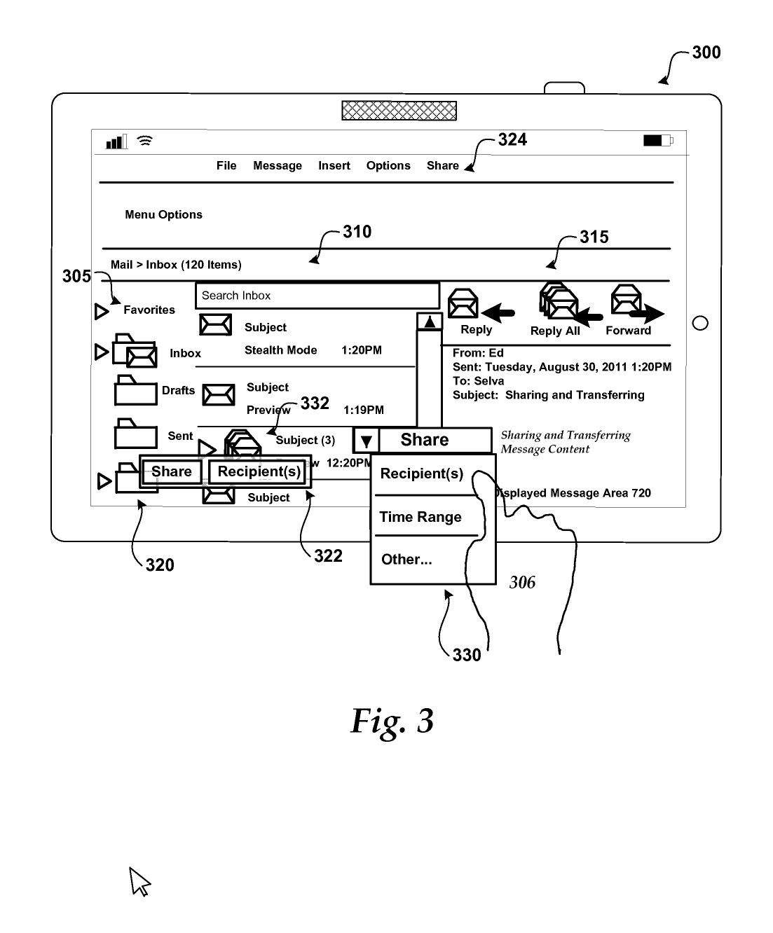

FIG. 3 shows a display illustrating a messaging window that shows a user interacting with electronic messages and selecting messaging content to share. As illustrated, window 300 includes a folder list 305, a message list 310, and a preview area 315. More or fewer areas may be included within window 300. The folder list may be used to show different folders that may be selected to populate the message list (e.g. selecting a deleted items folder to show deleted items). A preview area may be used to show message content that is associated with a selected message/message thread. A graphical indicator, such as an icon and/or coloring/highlighting, may be displayed to indicate a selected message.

Window 300 may be a window that is associated with a desktop application, a mobile application and/or a web-based application (e.g. displayed by a browser). For example, a web browser may access an electronic mail service, an email application on a computing device may be configured to compose/send/receive emails from one or more different services, and the like.

Message list 310 shows single messages and message threads. The messages in message thread may be expanded by selecting the expand/collapse icon before the message thread. In the current example, a user has selected thread 332 to share using menu 330. One or more user interfaces of one or more types may be used to interact with and to select messaging content to share. For example, UI 322 may provide different options, context menu 330 may be used, interface 324 may be used, a menu within a menu bar, a menu item selected from a ribbon user interface, a graphical menu, and the like. In the current example, menu 322, a context menu 330 and menu 324 are illustrated for sharing messaging content. Generally, the UIs are configured such that a user may easily interact with and select messaging content for sharing. For example, a user may simply select an option within a UI to share messaging content. Zero or more options may be displayed. For example, the option may be a single sharing option that when selected queries the user for a recipient to share the content with. The sharing UI may also include other options such as shown in context menu 330. As illustrated, the options show a selection for specifying recipients, a time range that is used to specify a duration for the sharing, and other options. UI 322 shows a share option and a recipient option. In response to a user selecting the share option, the selected messaging content is shared. According to an embodiment, a UI is displayed alpha blended such that a portion of the content beneath the display of the UI remains visible.

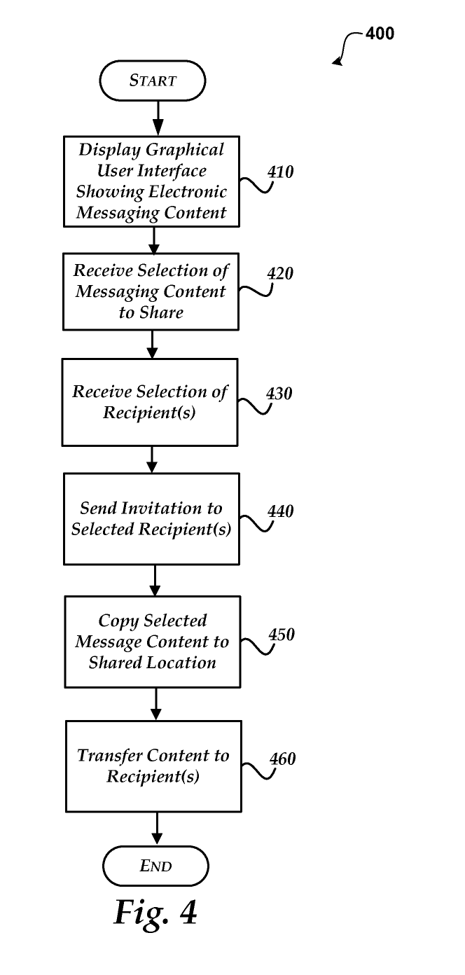

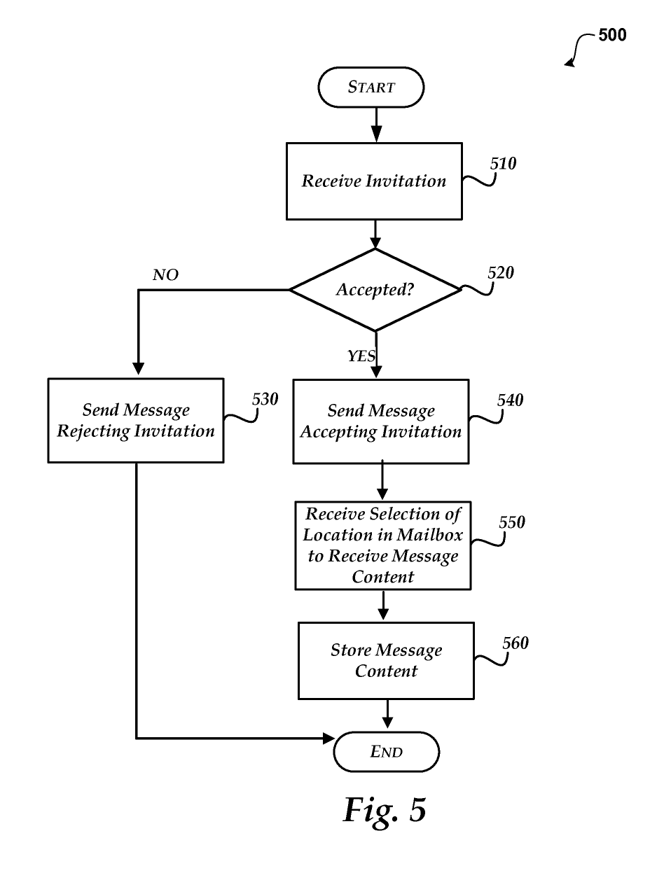

FIGS. 4-5 show illustrative processes for sharing and transferring message content. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the ordering of the operations may change and be performed in other orderings.

FIG. 4 shows a process for selecting message content and recipient(s) for sharing and transferring message content.

After a start operation, the process 400 flows to operation 410, where a graphical user interface is displayed to interact with and share messaging content including electronic messages. The messaging content may one or more of: email messages, SMS, MMS, and the like). The graphical user interface includes different user interface elements for interacting with and sharing the messaging content. For example, user interface elements may be used to select and share messaging content; sort messaging content (e.g. oldest to newest, newest to oldest, within a range, create/fire rules to share/unshared messaging content, filter messaging content and the like. The messaging content (e.g. electronic messages) may be displayed in folders, arranged in a list, arranged as threads, and/or arranged in different manners. The messages may be displayed by a client based application and/or by a server based application (e.g. enterprise, cloud based).

Flowing to operation 420, a request is received that selects messaging content to share with one or more recipients. The request may be received through the GUI and/or through some other method. For example, the request may be automatically generated in response to a rule being fired. The messaging content may include all/portion of a user's messaging content. For example, a user may select a single folder from their mailbox, their entire mailbox, one or more conversation threads, one or more subjects, a calendar, a portion of a calendar, a calendar between certain dates, tasks, and the like. The selected messaging content may be shared one time, for a period of time, and/or until the sharing relationship is ended. For example, when the content is shared one time, the existing messaging content that is selected is shared with the selected recipient(s). When the content is shared for a period of time, the existing messaging content that is selected is shared with the selected recipient(s) and updates to the selected messaging content is shared until the time period expires.

Transitioning to operation 430, a selection of one or more recipients to share the selected messaging content is received. The recipient(s) may be identified using different methods. For example, a contact book may be accessed, an email address may be used to identify a recipient, some other identifier (e.g. IM address, text address, . . . ) may be used, a project identifier, and the like may be used.

Moving to operation 440, an invitation may be sent to the selected recipient(s). The invitation is used in determining whether or not a recipient would like to have the selected messaging content transferred to them. A recipient may either accept/reject the invitation. According to an embodiment, the invitation expires after a predetermined period of time (e.g. one day, two days, one week, two weeks, . . . ).

Transitioning to operation 450, the selected message content is optionally copied to a shared location. Copying the selected messaging content to a shared location may assist in transferring the selected messaging content. For example, the messaging content may not be available from the user when they are not connected to a network. When the sharing involves future sharing of content, the shared location may be updated with content as it changes.

Flowing to operation 460, the selected messaging content is transferred to the selected recipient(s). According to an embodiment, the messaging content is transferred (copied) from the shared location to the recipient in response to the user accepting the invitation.

The process then moves to an end operation and returns to processing other actions.

FIG. 5 shows a process for accepting/rejecting an invitation to share message content.

After a start operation, the process 500 flows to operation 510, where an invitation to receive messaging content shared by a user is received.

Moving to decision operation 520, a determination is made as to whether the invitation is accepted/rejected. When the invitation is rejected, the process flows to operation 530. When the invitation is accepted, the process flows to operation 540.

At operation 530, a message is sent to the user that indicates that the user has rejected the invitation to share the messaging content.

At operation 540, a message is sent to the user that indicates that the user has accepted the invitation to share the messaging content.

Flowing to operation 550, the recipient may select a location where to store the message content. According to an embodiment, the recipient selects a location within their mailbox where to store the content. For example, the recipient may place the messaging content within their inbox, within a new folder, some other folder and/or some other location.

Transitioning to operation 560, the messaging content is stored as specified by the recipient.

The process then moves to an end operation and returns to processing other actions.

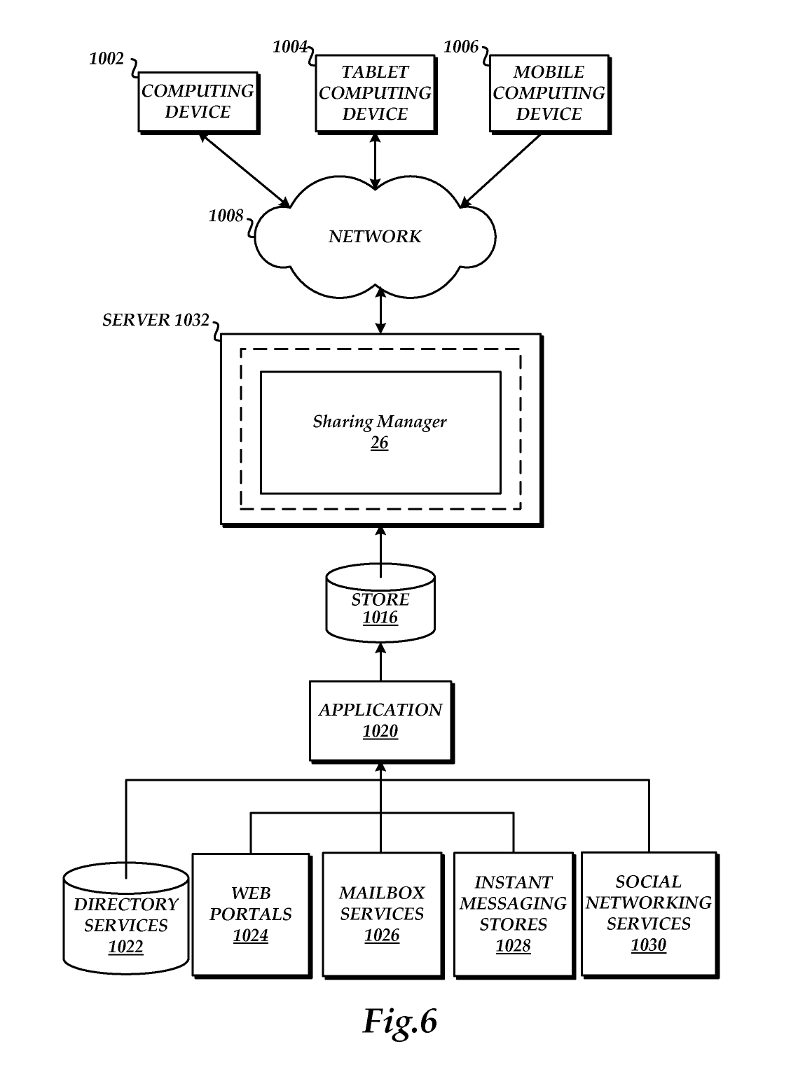

FIG. 6 illustrates a system architecture used in sharing messaging content, as described herein. Content used and displayed by the application (e.g. application 1020) and the sharing manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access sources and to prepare and display electronic messages. For example, server 1032 may access and share electronic messages for application 1020 to display at a client (e.g. a browser or some other window) and restore from a client. As one example, server 1032 may be a web server configured to provide messaging services (e.g. email, text messages, IM messages, and the like) to one or more users. Server 1032 may use the web to interact with clients through a network 1008. Server 1032 may also comprise an application program (e.g. a messaging application). Examples of clients that may interact with server 1032 include computing device 1002, which may include any general purpose personal computer, a tablet computing device 1004 and/or mobile computing device 1006 which may include smart phones. Any of these devices may obtain content from the store 1016.

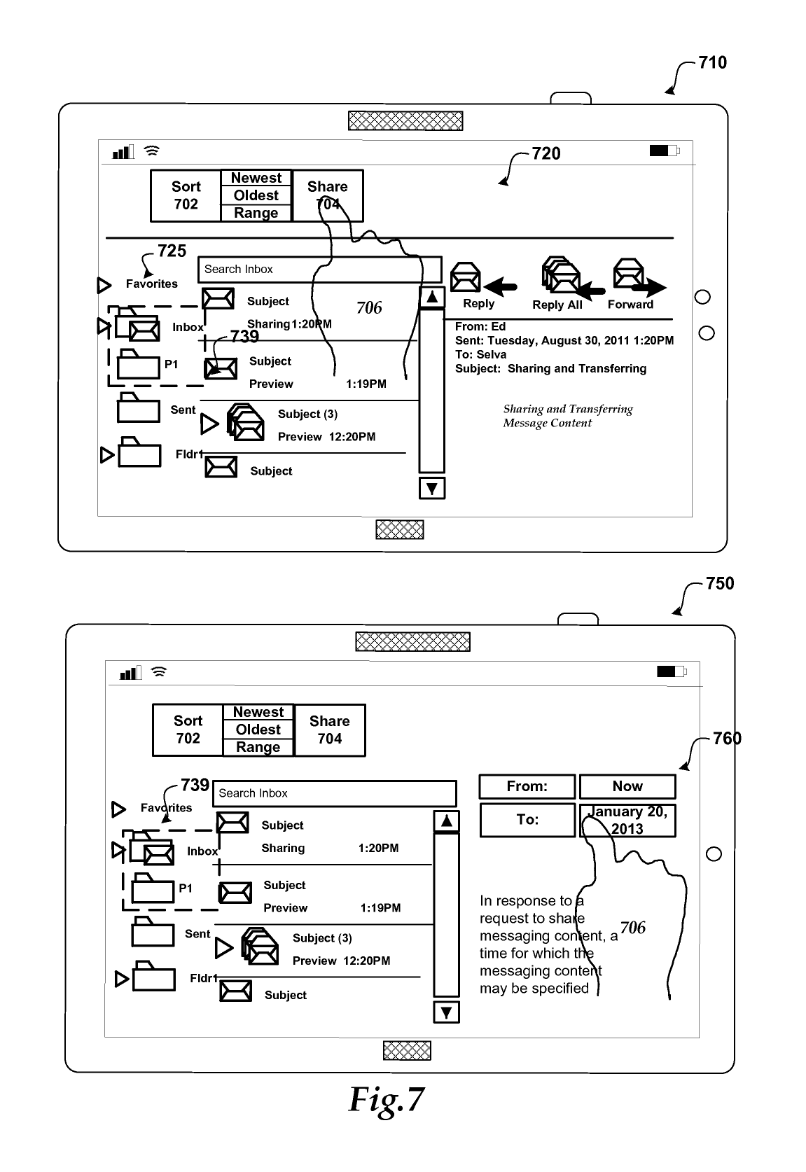

FIGS. 7-13 show exemplary displays illustrating sharing and transferring messaging content. The examples shown herein are for illustration purposes and not intended to be limiting.

FIG. 7 shows an exemplary landscape slate display showing sharing messaging content for a specified period of time.

Display 710 shows a display showing a list of messaging content including folders 725 that comprise electronic messages. As illustrated, user 706 has selected messaging content 739 that includes two folders (Inbox and P1) within a user's mailbox. After selecting the messaging content, user 706 is selecting the share operation 704 to share the selected messaging content.

Display 750 shows user 706 entering values 760 that are used for determining how long to share the selected messaging content. As illustrated, user 706 has entered to share the messaging content from now until a date in the future (e.g. Jan. 20, 2013). Other times may be entered. After the user has entered the desired parameter(s), the items are shared with the selected recipient(s) using the received values.

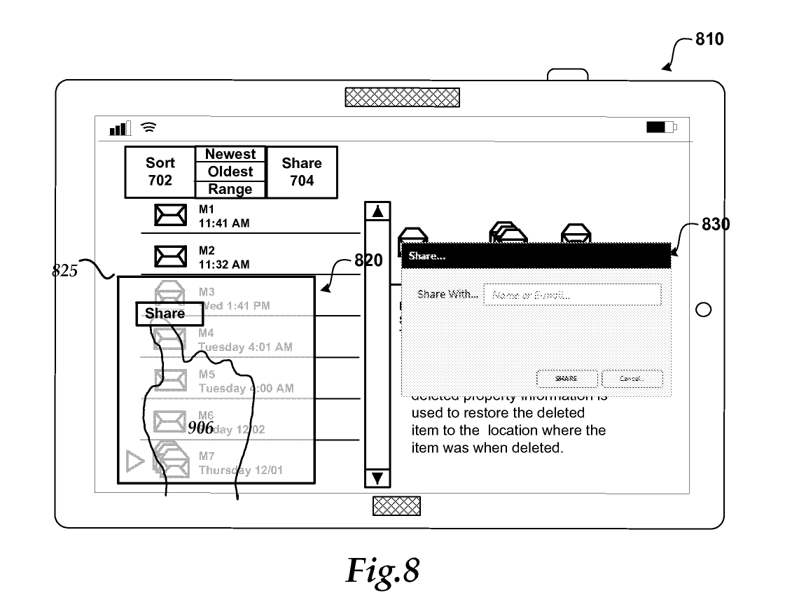

FIG. 8 shows an exemplary landscape slate display showing selection of electronic messages to share with one more recipients.

Display 810 shows a display showing a list 825 of deleted electronic messages. As illustrated, user 806 has selected messages M3-M7 for sharing. In response to selecting the share button, a share user interface element 830 is displayed. Share user interface element 860 shows a text input box that allows a user to enter a recipient using names and/or email addresses. As discussed herein, other methods may be used to identify the recipient(s). When the user selects the “SHARE” option from user interface 830, the selected messaging content 820 is shared with the selected recipient(s). According to an embodiment, the recipient(s) are verified before sharing the messaging content. The verification may include different operations. For example, a check may be made to ensure that the email address is valid, the recipient is authorized to receive the selected messaging content and the like.

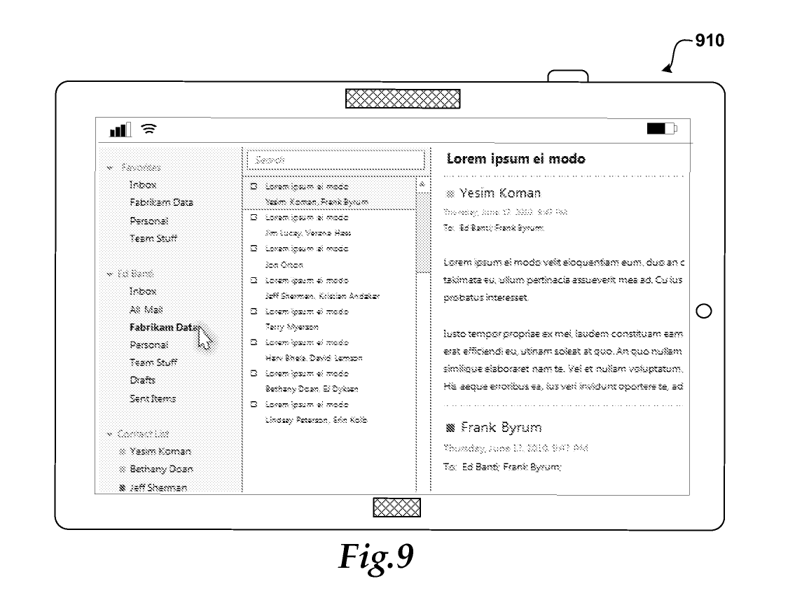

FIGS. 9-13 shows an example of sharing a folder and its content with a recipient.

FIG. 9 shows an exemplary landscape slate display showing selection of a folder.

Display 910 shows a display illustrating messaging content. As illustrated, the folder “Fabrikum Data” is selected. In response to the selection, the messaging content (e.g. electronic messages) are displayed. In the current example, in response to selecting the Fabrikum Data folder to share, the displayed content in display 910 is copied to the selected recipient(s).

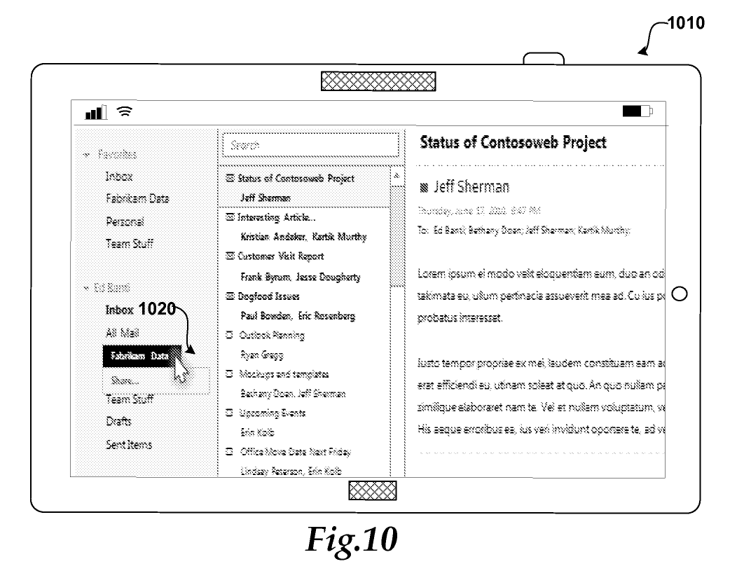

FIG. 10 shows an exemplary landscape slate display showing selection of a folder to share.

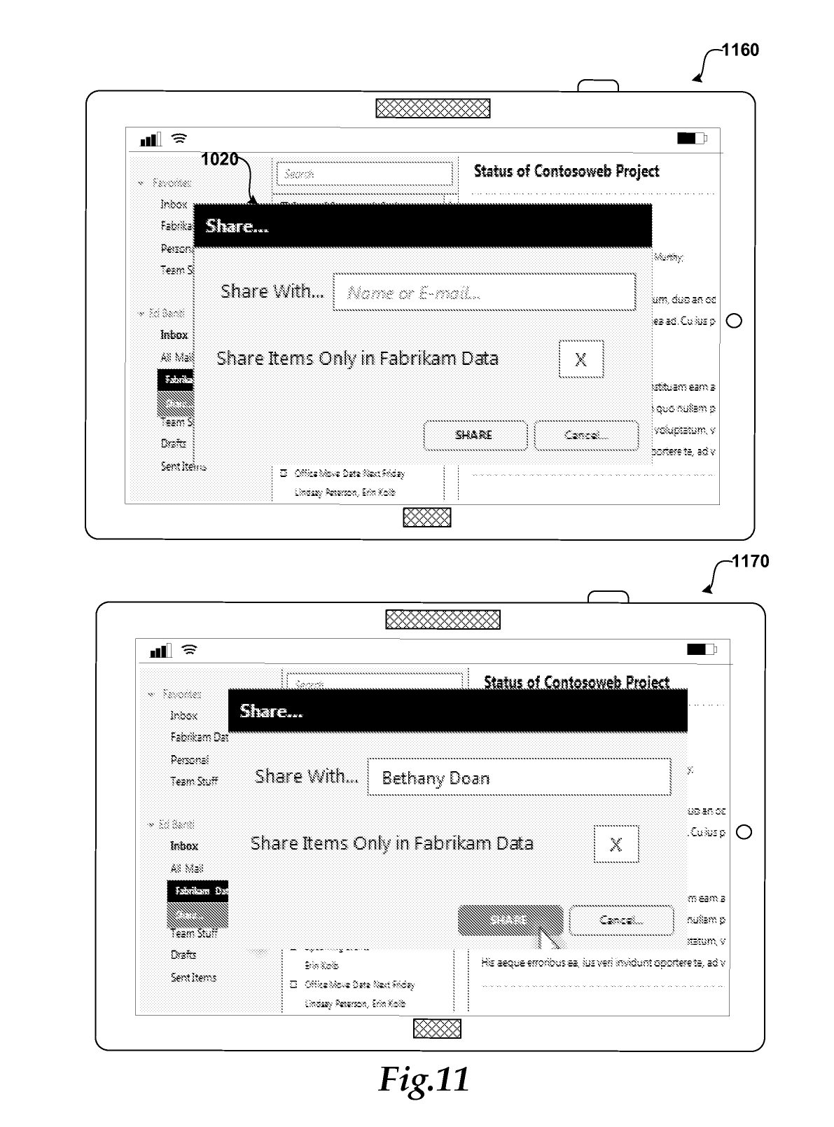

Display 10110 shows a display illustrating a user selecting the “Fabrikum Data” to share. As illustrated, the folder “Fabrikum Data” is selected to possibly share. In response to the selection, UI 1020 is displayed that includes a “SHARE” option. In response to selecting the SHARE option, a share user interface element is displayed (See FIG. 11).

FIG. 11 shows an exemplary landscape slate display showing selecting a recipient.

Display 1160 shows a display illustrating a user interface element 1020 for entering one or more recipients with which to share the selected messaging content. UI 1020 also shows options for restricting the messing content to share to the content in the selected folder as well as options to share the content and to cancel the sharing operation.

Display 1170 shows a display illustrating a user interface element 1020 after a name (Bethany Doan) has been entered. When the user is ready to share the messaging content, the SHARE option in UI 1020 is selected to begin the sharing.

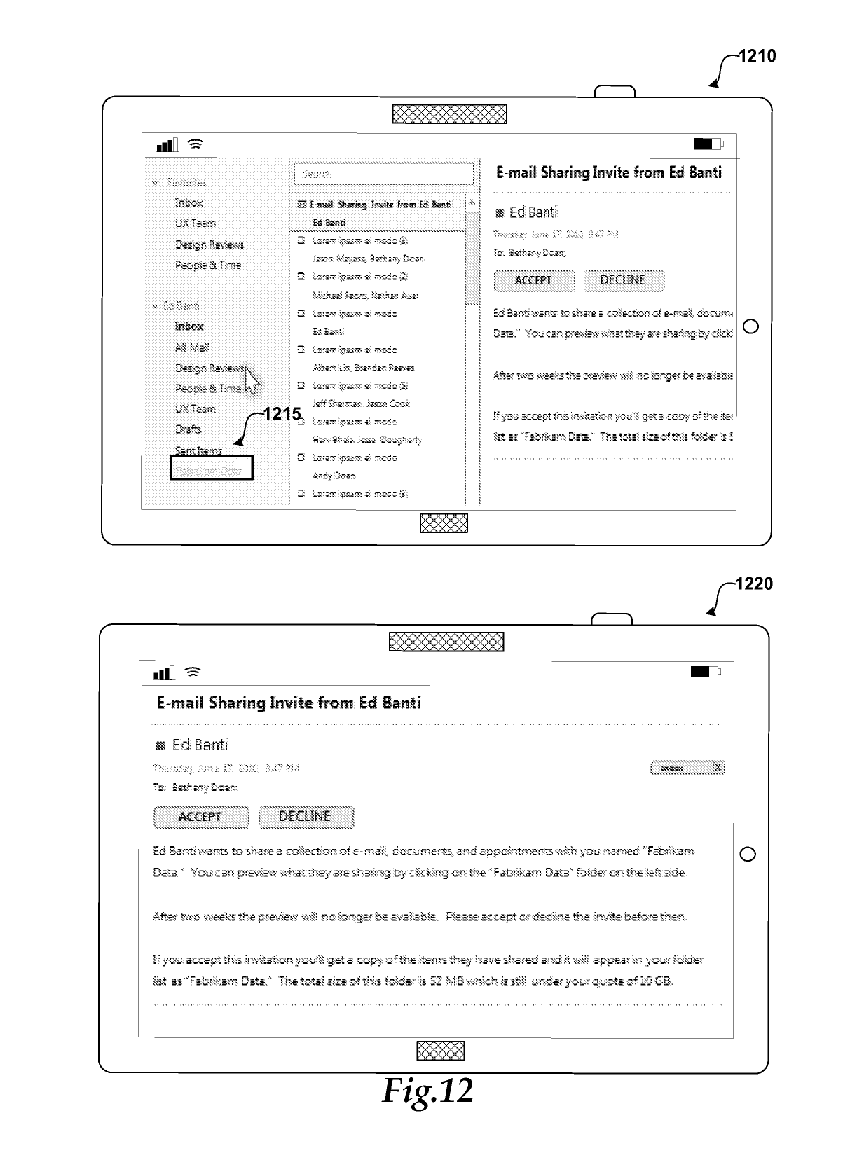

FIG. 12 shows an exemplary landscape slate display illustrating an example invitation received by a recipient to show content.

Display 1210 shows a display illustrating a user (in this case Bethany Doan) receiving a sharing invitation from Ed Banti.

Display 1220 shows an example sharing invitation. The sharing invitation includes options for accepting/declining the invitation. A recipient may preview the messaging content that is selected for sharing. According to an embodiment, the folder selected for sharing is displayed within the recipient's mailbox (1215). If the recipient selects folder 1215, the messaging content is displayed. If the user declines the invitation then folder 1215 is removed. The invitation may be valid for a predetermined period of time (e.g. two weeks). The location of where the content is stored within the recipient's mailbox may be predefined and/or selected by the user. In the current example, the shared messaging content will be copied to and stored in the Fabrikam Data 1215 folder. The invitation as illustrated also includes a size of the shared messaging content and a size of the recipient's quota.

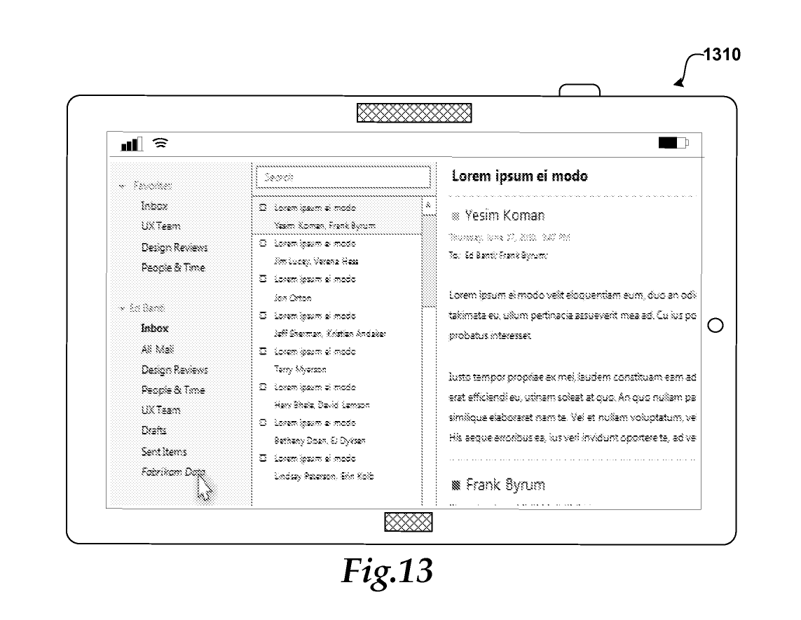

FIG. 13 shows an exemplary landscape slate display illustrating a recipients mailbox after accepting an invitation to share.

Display 1310 shows the recipients mailbox (in this case Bethany Doan) after accepting the sharing invitation from Ed Banti. As can be seen, the mailbox includes the “Fabrikum Data” within the list of the recipient's folders.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for sharing and transferring messaging content, comprising:
displaying messaging content that is associated with a user;
receiving a request to share at least a portion of the messaging content with a recipient;
accessing the messaging content that is associated with the user; and
transferring the messaging content to the recipient.

2. The method of claim 1, further comprising sending an invitation to the recipient to accept the messaging content from the user and in response to receiving an acceptance transferring the messaging content to the recipient.

3. The method of claim 1, further comprising validating the recipient to help ensure that the recipient is an authorized recipient.

4. The method of claim 1, further comprising copying the messaging content to a common location before transferring the messaging content to the recipient.

5. The method of claim 1, wherein receiving the request to share the at least the portion of the messaging content with the recipient comprises determining a time period to share the messaging content.

6. The method of claim 1, wherein receiving the request to share the at least the portion of the messaging content with the recipient comprises receiving a selection of a folder that stores electronic messages.

7. The method of claim 1, wherein receiving the request to share the at least the portion of the messaging content with the recipient comprises receiving a selection of a thread comprising electronic messages to share.

8. The method of claim 1, further comprising displaying a preview of the messaging content to share in response to receiving a preview selection.

9. The method of claim 1, further comprising automatically expiring the invitation after a predetermined period of time.

10. The method of claim 1, further comprising receiving a selection from the recipient indicating a location within the recipient's mailbox to place the messaging content from the user.

11. A computer-readable medium having computer-executable instructions for sharing and transferring messaging content, comprising:
displaying messaging content comprising electronic messages that is associated with a user;
receiving a request to share at least a portion of the messaging content with a recipient;
validating the recipient;
accessing the messaging content that is associated with the user; and
copying the messaging content to a common location; and
transferring from the common location the messaging content to the recipient.

12. The computer-readable medium of claim 11, further comprising sending an invitation to the recipient to accept the messaging content from the user and in response to receiving an acceptance transferring the messaging content to the recipient.

13. The computer-readable medium of claim 11, wherein receiving the request to share the at least the portion of the messaging content with the recipient comprises determining a time period to share the messaging content.

14. The computer-readable medium of claim 11, wherein receiving the request to share the at least the portion of the messaging content with the recipient comprises receiving a selection of either one or more of: a folder that stores electronic messages and a selection of a thread comprising electronic messages to share.

15. The computer-readable medium of claim 11, further comprising displaying a preview of the messaging content to share in response to receiving a preview selection.

16. The computer-readable medium of claim 11, further comprising receiving a selection from the recipient indicating a location within the recipient's mailbox to place the messaging content from the user.

17. A system for sharing and transferring messaging content, comprising:
a display;
a network connection that is coupled to a network;
a processor and a computer-readable medium;
an operating environment stored on the computer-readable medium and executing on the processor; and
a process operating under the control of the operating environment and operative to perform actions, comprising:
displaying messaging content comprising electronic messages that is associated with a user;
receiving a request to share at least a portion of the messaging content with a recipient;
validating the recipient;
sending an invitation to the recipient to accept the messaging content;
accessing the messaging content that is associated with the user; and
copying the messaging content to a common location; and
transferring from the common location the messaging content to the recipient.

18. The system of claim 17, wherein receiving the request to share the at least the portion of the messaging content with the recipient comprises determining a time period to share the messaging content.

19. The system of claim 17, wherein receiving the request to share the at least the portion of the messaging content with the recipient comprises receiving a selection of either one or more of: a folder that stores electronic messages and a selection of a thread comprising electronic messages to share.

20. The system of claim 17, further comprising displaying a preview of the messaging content to share in response to receiving a preview selection.
